(19) United States
(12) Patent Application Publication
(10) Pub. No.: US 2005/0125389 A1
(43) Pub. Date: Jun. 9, 2005

(54) Providing access to a service using a service engine

(75) Inventors: Timothy A. Hazzard, Plano, TX (US); Sanjay P. Lobo, Allen, TX (US)

Correspondence Address: BAKER BOTTS L.L.P., 2001 ROSS AVENUE, 6TH FLOOR, DALLAS, TX, 75201, US

(73) Assignee: Electronic Data Systems Corporation

(21) Appl. No.: 10/733,025

(22) Filed: Dec. 9, 2003

(51) Int. Cl. G06F 17/30

(52) U.S. Cl. 707/3

(57) ABSTRACT

Providing access to a service includes providing a subset of a directory of services associated with third party vendors to a portal communicating with a user system. A service comprises use of a software application. A selection of selected services is received from the user system. The selected services have conditions governing access to the selected services. A user identifier is received and linked with the selected services. The user identifier is allowed access to the selected services according to the one or more conditions.

### TECHNICAL FIELD

This invention relates generally to the field of software applications and more specifically to providing access to a service using a service engine.

### BACKGROUND

Services may be provided to users to allow the users to use the service. Known techniques for providing services include allowing a user to download a software application for a fee. These known techniques, however, may not be economically efficient in certain situations. It is generally desirable to be economically efficient.

### SUMMARY OF THE DISCLOSURE

In accordance with the present invention, disadvantages and problems associated with previous techniques for providing services may be reduced or eliminated.

According to one embodiment of the present invention, providing access to a service includes providing a subset of a directory of services associated with third party vendors to a portal communicating with a user system. A service comprises use of a software application. A selection of selected services is received from the user system. The selected services have conditions governing access to the selected services. A user identifier is received and linked with the selected services. The user identifier is allowed access to the selected services according to the one or more conditions.

Certain embodiments of the invention may provide one or more technical advantages. A technical advantage of one embodiment may be that a service system may offer a user access to the services, provide the user access to selected services, and send compensation for the access to the vendors associated with the selected services.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of one embodiment of a system for providing access to services using a service engine;

FIG. 2 is a block diagram of one embodiment of a service system of the system of FIG. 1; and

FIG. 3 is a flowchart demonstrating one embodiment of a method for providing access to services.

### DETAILED DESCRIPTION OF THE DRAWINGS

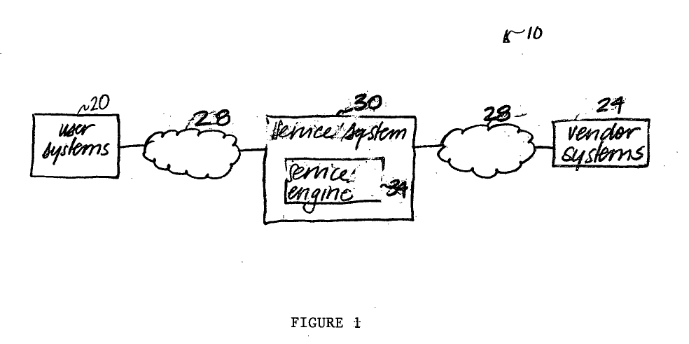

Embodiments of the present invention and its advantages are best understood by referring to FIGS. 1 through 3 of the drawings, like numerals being used for like and corresponding parts of the various drawings.

FIG. 1 is a block diagram of one embodiment of a system 10 for providing access to services using a service engine. System 10 may include a service system that allows users to access services offered by vendors. According to one example, the service system may offer a user access to the services, provide the user access to selected services, and send compensation for the access to the vendors associated with the selected services.

According to the illustrated embodiment, system 10 includes one or more user systems 20 and one or more vendor systems 24 coupled to a service system 30, which includes a service engine 28, through one or more communication networks 28 as illustrated. System 10, however, may include more, fewer, or other modules. According to one embodiment of operation, service system 26 displays to user systems 20 a directory of services offered by vendor systems 30. Service engine 28 may provide user systems 20 access to selected services, monitor the access to the selected services, and provide compensation to vendor systems 30 for the access to the selected services.

According to the illustrated embodiment, a user system 20 may allow a user to communicate with service system 26. A user may comprise, for example, a human, a device, or any other entity operable to request access to a service from service system 26 through a user system 20. A user may be identified by a user identifier comprising, for example, a text string that corresponds to one or more users. A user identifier may comprise, for example, a user name, a user address, a user code, or any other suitable string that corresponds to one or more users. User system 20 may operate on one or more computers, and may include appropriate input devices, output devices, storage media, processors, memory, or other components for receiving, processing, storing, or communicating information.

Vendor systems 24 allow vendors to communicate with service system 30. A vendor may comprise, for example, a company that sells, provides, or both sells and provides services in return for compensation such monetary compensation. A vendor may be a third party that is distinct from the entity operating service engine 34. A service may comprise, for example, use of a software application such as a standard or custom application. A vendor system 24 may operate on one or more computers, and may include appropriate input devices, output devices, storage media, processors, memory, other components for receiving, processing, storing, or communicating information.

Communication network 22 allows user systems 20 and vendor systems 24 to communicate with service system 26. Communication networks 22 may comprise all or a portion of a public switched telephone network (PSTN), a public or private data network, a local area network (LAN), a metropolitan area network (MAN), a wide area network (WAN), a global computer network such as the internet, a wireline or wireless network, a local, regional, or global communication network, an enterprise internet, other suitable network, or any combination of proceeding.

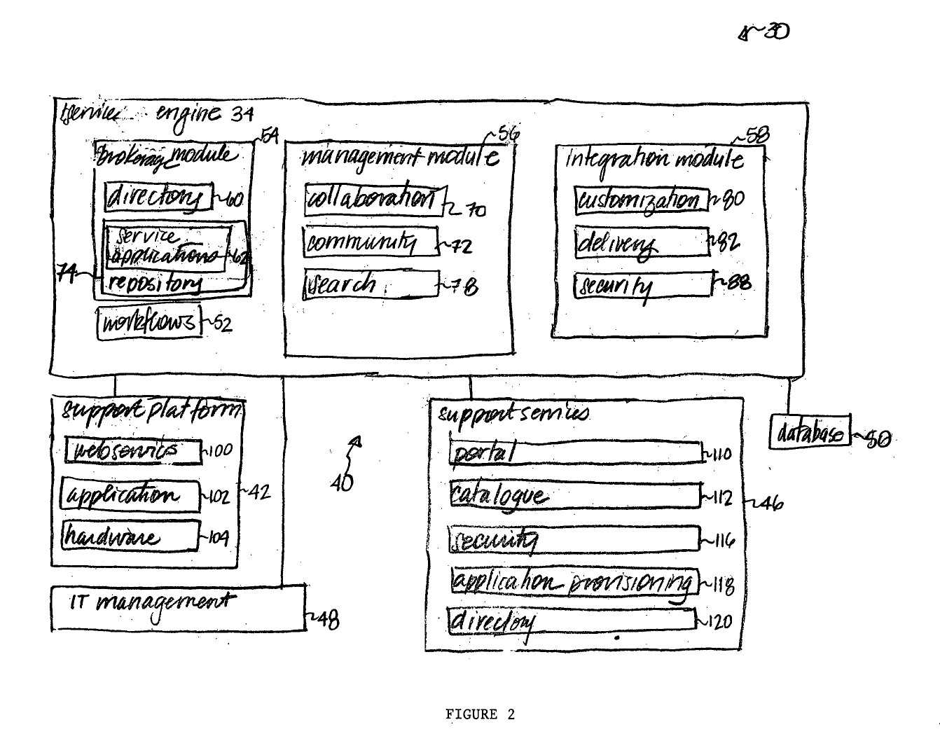

Service system 30 offers to user systems 20 access to services provided by vendor systems 24, and may allow for provisioning, monitoring, maintenance, and billing of the services. The operations may be provided in an automated fashion that requires little or no human intervention. Service system 30 may include a service engine 34. Service engine 34 may operate to sign up vendors that provide services, generate a directory of the services, and offer users access to the services. Service engine 34 may also operate to provide access to services selected by the users in accordance with service conditions, track the access of the services, and provide to the vendors payment by the users for the access to the services. Service engine 34 is described in more detail with reference to FIG. 2.

Alterations or permutations such as modifications, additions, or omissions may be made to system 10 without departing from the scope of the invention. System 10 may have more, fewer, or other modules. Moreover, the operations of system 10 may be performed by more, fewer, or other modules. For example, the operations of service engine 34 may be performed by more than one module. Additionally, operations of system 10 may be performed using any suitable logic comprising software, hardware, other logic, or any suitable combination of the preceding. As used in this document, “each” refers to each member of a set or each member of a subset of a set.

FIG. 2 is a block diagram of one embodiment of service system 30 of system 10 of FIG. 1. Service system 30 provides a user access to a service. Providing a user access to a service may refer to allowing a user to use a software application associated with the service. According to the illustrated embodiment, service system 30 includes one or more modules 40 such as service engine 34, a support platform 42, one or more support services 46, an information technology (IT) management module 48, and a database 50 coupled as shown. Service system 30, however, may include more, fewer, or other modules.

According to one embodiment, service engine 34 manages modules that provide access to services. According to the illustrated embodiment, service engine 34 includes one or more workflows 52, a brokerage module 54, a management module 56, and an integration module 58. Service engine 34, however, may include more, fewer, or other modules.

Workflows 52 direct the operation of service engine 34. Brokerage module 54 brokers the services of vendors. According to one embodiment, brokerage module 54 receives service information describing the services. Service information for a service may comprise, for example, a description of the service, the vendor of the service, conditions governing access to the service, other information describing the service, or any combination of the preceding. Conditions govern access to a service and may be defined in, for example, a license agreement. Conditions may include a payment schedule and terms, restrictions on use, confidentiality and intellectual property requirement, or other condition that governs access to a service.

According to the embodiment, brokerage module 54 creates a directory 60 of services and hosts the service applications 62 that provide the services. Directory 60 may comprise a catalog of services that may be presented to user systems 20. Brokerage module 54 may create directory 60 by creating a service entry from the service information describing a service, and adding the service entry to directory 60.

Repository module 74 may be used to manage access provided to a community of users. As an example, an administrator may use repository function 74 to keep track of services that are available to the community of users and to modify the community of users. Repository module 74 may also be used to record the service conditions governing access to the services. Repository module 74 may include service applications 62.

Service applications 62 may include standard, customized, or both standard and customized applications. A standard application may refer to a software application that is mass produced for a large number of customers. An example of a standard application may include an Oracle suite application. A customized application may refer to a software application that is created or modified for one or more particular customers. An example of a customized application may include a web service interface that is created for a particular customer.

Management module 56 may be used to manage and support the services. Management module 56 may be used by a user such as an administrator to manage the services. As an example, an administrator may designate users that may access particular services. Management module 56 may support services by, for example, providing automated routing, load balancing, or performing any other operation for managing the services. Management module 56 may include other modules such as a collaboration module 70, a community module 72, and a search module 78. Management module 56, however, may include fewer, more, or other modules.

Collaboration module 70 may be used to set up access to services. As an example, collaboration module 70 may set up a service to be accessible by a user in response to a request from the user or an administrator. Community module 72 may be used to set up a community comprising users that can access one or more specified services. Community module 72 may allow users access to the services by linking the user identifiers of the users to the services and recording the linkage in a subscriber database.

Search module 78 allows a user to search directory 60 of services. According to one embodiment, a user may supply a search value of a search variable to search directory 60. A search variable may refer to a feature of the services, and may include, for example, the type of application, vendor, date posted, cost, or any other feature. A search value may refer to value of a search variable, and may comprise a string of one or more characters. Search module 78 may also allow a user to browse directory 60 of service applications 62. As an example, services may be organized in categories that the user may select to view the services in the categories.

According to one embodiment, integration module 58 provides a user access to a service. Integration module 58 may include modules such as a customization module 80, a delivery module 82, and a security module 88. Integration module 58, however, may include more, fewer, or other modules.

Customization module 80 may allow a user to customize the user interfaces. Customization may involve, for example, customizing a website through which the service may be accessed. Delivery module 82 provides the user access to the service. The access may be provided by executing a service application 62 for the service within a portal and allowing the user access to the service through the portal. A portal may refer to a point of entry to service system 30.

Delivery module 82 is responsible for packaging a requested application. Delivery module 82 may provide the application in the appropriate format and deliver the application according to the appropriate network protocol such as Simple Object Access Protocol (SOAP). Delivery module 82 may integrate with a metrics module of a web services module 100 to track usage of the service by a user. According to one embodiment, delivery module 82 may collect information according to metrics. The metrics may be used to, for example, measure usage of services.

Security module 88 determines whether a user has permission to access a service. Security module 88 may authenticate a user by, for example, validating a user identifier and a passcode using a subscriber database. A passcode may refer to a string of one or more characters that may be used to verify the identity of a user. Security module 88 may also verify whether a user has access to a service by determining whether the user identifier of the user has been linked to the service. According to one embodiment, a user may access more than one service with a single sign-on procedure using, for example, a password. According to the embodiment, the user identifier along with a passcode may be linked to multiple services. Security module 88 may provide security using virtual private networks (VPNs) and Rivest-Shamir-Adleman (RSA) technologies.

Support platform 42 provides software and hardware support for service engine 34. According to the illustrated embodiment, support platform 42 includes a web services platform 100, an application support platform 102, and a hardware support platform 104. Support platform 42, however, may include more, fewer, or other modules.

Web services support platform 100 provides support for web services through which user system 20 or vendor system 24 may access service engine 34. Web services support platform 100 may comprise one or more applets of functionality that operate according to any suitable protocol such as Web Services Description Language (WSDL) or other protocol. The web services may be delivered through a web-centric portal, such as through common web services available through other providers. The services may be delivered using basic portal provisioning capabilities. According to one embodiment, features may allow for the ability to imbed code into a user developed application.

Web services support platform 100 may include a metrics module that monitors usage of a service and the metrics displayed through a web portal. Usage may be tracked in any suitable manner. For example, usage may refer to the amount of time, measured in, for example, days, weeks, months, or years, that a user is allowed to access the service. As another example, usage may refer to the amount of time that a user actually accesses the service. As yet another example, usage may refer to the number of times the user accesses the service. Usage may refer to any other suitable manner of tracking how the user accesses the service. Web services support platform 100 may also be used to designate a priority for the users, such that users with a higher priority may be given preferential access over the users with a lower priority.

Application support platform 102 provides application support to service engine 34, and hardware support platform 104 provides hardware support for service engine 34. Hardware support platform 104 may comprise, for example, one or more computer systems such as one or more server systems. Scalability of hardware support platform 104 may be provided via Blade technology. If an application exceeds capacity, Blade technology may be leveraged to provide for an additional CPU that can be dynamically provisioned. If demand on a server reaches or exceeds a predetermined capacity, then the blades can be brought online to support additional processing capacities.

Support services 46 manages services that support the operation of service engine 34. According to the illustrated embodiment, support services 46 include portal services 110, catalog services 112, security services 116, application provisioning services 118, and directory services 120. Support services 46, however, may include more, fewer, or other services.

Portal services 110 may provide a portal through which a user system 20 or vendor system 24 may access service engine 34. The portal may comprise, for example, an interface such a graphical user interface for accessing directory 60 of services, a dashboard for monitoring, management, or both for the services, or other suitable portal for accessing service engine 34. Portal services 110 may allow for customization of portal to, for example, provide delivery of different levels of services to different users. According to one embodiment, registered users may access and use the services, while non-registered users may only have access to browse the catalog of services. Catalog services 112 provides a storefront for directory 60 of services. Catalog services 112 may allow a user to view, search for, and select services from directory 60. Catalog services 112 may be integrated with an order management system in order to provide real-time service inventory.

Security services 116 may support security module 88 of integration module 58. Application provisioning services 118 provision a service application in order to allow a user to access the application. According to one embodiment, for a given application, a dedicated blade or partitioned dedicated compartment may be established for the user. After the infrastructure is established, the software, database, and network configurations may be provisioned. For each application added to the provisioning service, a new workflow may be established. For web services, a single service for delivering the web service may be provided. Directory services 120 may support directory 60 of brokerage module 54.

IT management 48 may provide hardware provisioning, environmental monitoring, utility compute operation, or other functionality. Hardware provisioning prepares pre-racked servers for operational use. The servers may also be monitored. Environmental monitoring tracks identification and performance concerns and provides near real-time resolution. A utility compute operation provides for monitoring CPU utilization and directing processing of transactions to hardware that have greater available resources.

Database 50 stores data used by the modules, and may include, for example, directory 60 of services, a subscriber database that may be used to verify a user and to link a user identifier to one or more services, or other information. Database 50 may include Random Access Memory (RAM), Read Only Memory (ROM), magnetic drives, disk drives, Compact Disk (CD) Drives, Digital Video Disk (DVD) drives, removable media storage, any other suitable data storage device, or a combination of any of the preceding.

Database 50, service engine 34, support platform 42, support services 46, and IT management 48 may each operate on one or more computers, and may include appropriate input devices, output devices, mass storage media, processors, memory, or other components for receiving, processing, storing, and communicating information according to the operation of system 30. As used in this document, the term “computer” refers to any suitable device operable to accept input, process the input according to predefined rules, and produce output, for example, a personal computer, work station, network computer, wireless telephone, personal digital assistant, one or more microprocessors within these or other devices, or any other suitable processing device.

Database 50, service engine 34, support platform 42, support services 46, and IT management 48 may be integrated or separated according to particular needs. If any of database 50, service engine 34, support platform 42, support services 46, or IT management 48 are separated, they may be coupled to each other using a local area network (LAN), a metropolitan area network (MAN), a wide area network (WAN), a global computer network such as the Internet, or any other appropriate wire line, wireless, or other link.

Alterations or permutations such as modifications, additions, or omissions may be made to system 30 without departing from the scope of the invention. System 30 may have more, fewer, or other modules. Moreover, the operations of system 30 may be performed by more, fewer, or other modules. For example, the operations of brokerage module 54 and management module 56 may be performed by one module, or the operations of integration module 58 may be performed by more than one module. Additionally, operations of system 30 may be performed using any suitable logic comprising software, hardware, other logic, or any suitable combination of the preceding.

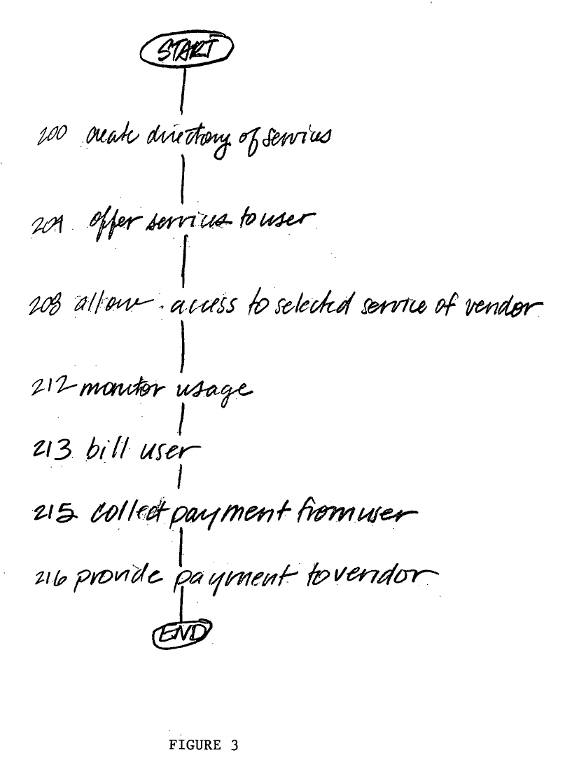

FIG. 3 is a flowchart demonstrating one embodiment of a method for providing access to services. The method may be executed according to a workflow 52. The method begins at step 200, where a directory 60 of services is created. Service engine 34 may create directory 60 by receiving service information from vendor systems 24, creating a service entry from the service information, and adding the service entry to directory 60. The services are offered to a user at step 204. Service engine 34 may offer the services by sending directory 60 through a web portal.

Access to selected services is allowed at step 208. A user may select a service by searching directory 60 and selecting a service from directory 60. Service engine 34 may allow access to the selected services by storing a user identifier and passcode corresponding the user in a subscriber database, and linking the user identifier to the selected services. When the user requests access, service engine 34 may authenticate the user according to the subscriber database, and provision software and hardware to provide access to the user.

Usage is monitored at step 212. Service engine 34 may monitor usage according to, for example, the amount of time a user is allowed to access the service, the amount of time a user actually accessed the service, the number of times a user accesses the service, or other suitable matter. The user is billed for payment at step 213. Service engine 34 may determine the amount of payment according to the usage and the service conditions governing the access to the service. Payment is collected from the user at step 215. Payment for the usage is provided to the vendor at step 216. Service engine 34 may then provide the payment to the vendor, either before or after receiving payment from the user. After providing payment, the method terminates.

Alterations or permutations such as modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of one embodiment may be that a service system may offer a user access to the services, provide the user access to selected services, and send compensation for the access to the vendors associated with the selected services.

While this disclosure has been described in terms of certain embodiments and generally associated methods, alterations and permutations of the embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

To aid the Patent Office and any readers of any patent issued on this application in interpreting the claims appended hereto, applicants wish to note that they do not intend any of the appended claims to invoke paragraph 6 of 35 U.S.C. § 112 as it exists on the date of filing hereof unless the words “means for” or “step for” are used in the particular claim.

1. A method for providing access to a service, comprising:
providing at least a subset of a directory of a plurality of services to a portal communicating with a user system, the plurality of services associated with a plurality of third party vendors, a service of the plurality of services comprising use of a software application;
receiving a selection of one or more selected services of the plurality of services from the user system, the one or more selected services associated with one or more conditions governing access to the one or more selected services;
receiving a user identifier;
linking the one or more selected services with the user identifier; and
allowing the user identifier access to the one or more selected services according to the one or more conditions.

2. The method of claim 1, wherein providing at least the subset of the directory of the plurality of services to the portal communicating with the user system further comprises:
receiving a search value of a search variable from the user system;
identifying the subset of the directory according to the search value; and
providing at least the subset of the directory.

3. The method of claim 1, wherein providing at least the subset of the directory of the plurality of services to the portal communicating with the user system further comprises:
providing a list of a plurality of categories of the plurality of services;
receiving a selected category of the plurality of categories from the user system, the selected category comprising the subset of the directory; and
providing at least the subset of the directory.

4. The method of claim 1, wherein allowing the user identifier access to the one or more selected services according to the one or more conditions further comprises:
verifying a passcode corresponding to the user identifier; and
providing the user identifier access to the one or more selected services in response to verifying the passcode, the one or more selected services comprising at least one service furnished by at least one third party vendor.

5. The method of claim 1, wherein allowing the user identifier access to the one or more selected services according to the one or more conditions further comprises:
determining usage of access to the one or more selected services;
calculating compensation for the usage according to the one or more conditions; and
providing the compensation to at least one third party vendor furnishing the one or more selected services.

6. The method of claim 1, wherein allowing the user identifier access to the one or more selected services according to the one or more conditions further comprises allowing the user identifier access to the one or more selected services through the portal.

7. A system for providing access to a service, comprising:
a database operable to store a directory of a plurality of services; and
a service engine coupled to the database and operable to:
provide at least a subset of the directory of the plurality of services to a portal communicating with a user system, the plurality of services associated with a plurality of third party vendors, a service of the plurality of services comprising use of a software application;
receive a selection of one or more selected services of the plurality of services from the user system, the one or more selected services associated with one or more conditions governing access to the one or more selected services;
receive a user identifier;
link the one or more selected services with the user identifier; and
allow the user identifier access to the one or more selected services according to the one or more conditions.

8. The system of claim 7, the service engine operable to provide at least the subset of the directory of the plurality of services to the portal communicating with the user system by:
receiving a search value of a search variable from the user system;
identifying the subset of the directory according to the search value; and
providing at least the subset of the directory.

9. The system of claim 7, the service engine operable to provide at least the subset of the directory of the plurality of services to the portal communicating with the user system by:
providing a list of a plurality of categories of the plurality of services;
receiving a selected category of the plurality of categories from the user system, the selected category comprising the subset of the directory; and
providing at least the subset of the directory.

10. The system of claim 7, the service engine operable to allow the user identifier access to the one or more selected services according to the one or more conditions by:
verifying a passcode corresponding to the user identifier; and
providing the user identifier access to the one or more selected services in response to verifying the passcode, the one or more selected services comprising at least one service furnished by at least one third party vendor.

11. The system of claim 7, the service engine operable to allow the user identifier access to the one or more selected services according to the one or more conditions by:
determining usage of access to the one or more selected services;
calculating compensation for the usage according to the one or more conditions; and
providing the compensation to at least one third party vendor furnishing the one or more selected services.

12. The system of claim 7, the service engine operable to allow the user identifier access to the one or more selected services according to the one or more conditions by allowing the user identifier access to the one or more selected services through the portal.

13. Software for providing access to a service, the software embodied in a medium and when executed operable to:
provide at least a subset of a directory of a plurality of services to a portal communicating with a user system, the plurality of services associated with a plurality of third party vendors, a service of the plurality of services comprising use of a software application;
receive a selection of one or more selected services of the plurality of services from the user system, the one or more selected services associated with one or more conditions governing access to the one or more selected services;
receive a user identifier;
link the one or more selected services with the user identifier; and
allow the user identifier access to the one or more selected services according to the one or more conditions.

14. The software of claim 13, operable to provide at least the subset of the directory of the plurality of services to the portal communicating with the user system by:
receiving a search value of a search variable from the user system;
identifying the subset of the directory according to the search value; and
providing at least the subset of the directory.

15. The software of claim 13, operable to provide at least the subset of the directory of the plurality of services to the portal communicating with the user system by:
providing a list of a plurality of categories of the plurality of services;
receiving a selected category of the plurality of categories from the user system, the selected category comprising the subset of the directory; and
providing at least the subset of the directory.

16. The software of claim 13, operable to allow the user identifier access to the one or more selected services according to the one or more conditions by:
verifying a passcode corresponding to the user identifier; and
providing the user identifier access to the one or more selected services in response to verifying the passcode, the one or more selected services comprising at least one service furnished by at least one third party vendor.

17. The software of claim 13, operable to allow the user identifier access to the one or more selected services according to the one or more conditions by:
determining usage of access to the one or more selected services;
calculating compensation for the usage according to the one or more conditions; and
providing the compensation to at least one third party vendor furnishing the one or more selected services.

18. The software of claim 13, operable to allow the user identifier access to the one or more selected services according to the one or more conditions by allowing the user identifier access to the one or more selected services through the portal.

19. A system for providing access to a service, comprising:
means for providing at least a subset of a directory of a plurality of services to a portal communicating with a user system, the plurality of services associated with a plurality of third party vendors, a service of the plurality of services comprising use of a software application;
means for receiving a selection of one or more selected services of the plurality of services from the user system, the one or more selected services associated with one or more conditions governing access to the one or more selected services;
means for receiving a user identifier;
means for linking the one or more selected services with the user identifier; and
means for allowing the user identifier access to the one or more selected services according to the one or more conditions.

20. A method for providing access to a service, comprising:
providing at least a subset of a directory of a plurality of services to a portal communicating with a user system, the plurality of services associated with a plurality of third party vendors, a service of the plurality of services comprising use of a software application, the subset of a directory provided by;
providing a list of a plurality of categories of the plurality of services;
receiving a selected category of the plurality of categories from the user system;
receiving a search value of a search variable from the user system;
identifying the subset of the directory according to the search value and to the selected category; and
providing at least the subset of the directory;
receiving a selection of one or more selected services of the plurality of services from the user system, the one or more selected services associated with one or more conditions governing access to the one or more selected services;
receiving a user identifier;
linking the one or more selected services with the user identifier; and
allowing the user identifier access to the one or more selected services through the portal according to the one or more conditions, the access allowed by:
verifying a passcode corresponding to the user identifier;
providing the user identifier access to the one or more selected services in response to verifying the passcode, the one or more selected services comprising at least one service furnished by at least one third party vendor;
determining usage of access to the one or more selected services;
calculating compensation for the usage according to the one or more conditions; and
providing the compensation to at least one third party vendor furnishing the one or more selected services.
